(19) United States
(12) Patent Application Publication
(10) Pub. No.: US 2019/0030551 A1
(43) Pub. Date: Jan. 31, 2019

(54) FOAM SPREADING NOZZLE

(71) Applicant: Dwight Williams, Brady, TX (US)

(72) Inventor: Dwight Williams, Brady, TX (US)

(21) Appl. No.: 16/046,616

(22) Filed: Jul. 26, 2018

Related U.S. Application Data
(60) Provisional application No. 62/538,114, filed on Jul. 28, 2017.

(51) Int. Cl. B05B 7/00

(52) U.S. Cl. CPC B05B 7/0018

(57) ABSTRACT

Disclosed invention is an improvement on nozzles used to discharge foam. The invention uses a plurality if tubes to alter the characteristics of the foam as it leaves the nozzle to impart additional speed while at the same time reducing the turbulence that can impact foam integrity.

### PRIORITY/CROSS REFERENCE TO RELATED APPLICATION

This application claims priority to Provisional Patent Application No. U.S. 62/538,114 entitled “Foam Spreading Nozzle” by Dwight Williams filed on Jul. 28, 2017. That application is incorporated by reference in its entirety.

### FIELD OF THE INVENTION

The field of this invention involves nozzles for both portable and fixed systems that project an aeriated foam for fighting industrial fires. This invention enhances nozzles used in those applications. The invention may be used to project fluid or dry chemicals as applicable.

### BACKGROUND OF THE INVENTION

Firefighters use foam fire suppressants in situations where water alone would be ineffective, such as fires in fuel storage tanks. Foam is a mixture of air, foam agent, and water that has a lower density than the liquid on fire. In fire fighting operations, the foam is projected where it spreads out over the surface of the liquid and forms a foam blanket. The objective of the foam blanket is to cover the entire surface of the fire, extinguishing the fire by blocking the oxygen source. The foam blanket also separates the liquid fuel from the vaporized fuel. The foam blanket eliminates the fuel source from the vaporized fuel while at the same time preventing more fuel from vaporizing, cooling the surface of the liquid fuel by evaporation, and depriving the fuel of oxygen. In this disclosure, it will also be understood that dry chemicals may also be projected for similar effects.

Due to the volume of foam needed to extinguish a fire, firefighters typically create the foam they need at the site of the fire. Foam forms when foam agent is introduced to a flow of water, usually moving at a high rate of speed. The water/foam agent solution is introduced to the air and agitated, usually in an aeration chamber, to create foam. Additionally or alternatively, the foam may expand as it leaves the nozzle on the way to the target location.

The amount the foam volume expands compared to the original volume of the water/foam agent solution is known as the expansion ratio. The expansion ratio indicates how much air may be introduced to the foam, changing the foam's density and speed. The expansion ratio impacts the thickness of the resulting foam wall, which impacts the way the foam reacts under fire because the foam bubble contains water. Lower expansion ratios lead to a denser foam wall with smaller bubbles in the foam that are more flame retardant and cooling, and are more resistant to breaking. However, a thicker foam wall moves slower and reduces the effective area. Higher expansion ratios create a foam with larger bubbles with thinner walls which can move faster and cover more area. However, a thicker foam wall may not have a sufficient density to extinguish a fire or cool the tank, and may break under less stress, negating the effectiveness of the foam.

When working with foam, pressure from pumping the supply of water impacts both foam creation and projection. The pressure created by the pump requires a balancing of factors. If the pump produces too little pressure, then insufficient foam projection occurs. If the pump produces too much pressure, the bubbles in the foam cannot form, negating the effectiveness of the foam. As a result, the pump should exert just enough pressure for adequate foam generation. The highest pressure from the pump that allows foam generation is different based on the different foam agents used.

Given the importance of the density of the foam and the surface area to be covered by the foam, it is important to find the optimum mechanism of foam delivery. Foam needs to be both thick enough to extinguish the fire and thin enough to cover the maximum area in the minimum time. While the force of the water flowing though the aeriation chamber will propel the resulting foam out at a corresponding velocity, the foam may become compromised if it moves fast or not cover enough area if it moves too slow. As a result, there is a need to create a foam delivery method and apparatus that preserves the integrity of the foam while at the same time increases the distance the foam may be projected.

While the term water is used, it is understood that other liquids may be used as long as they fulfill the same requirements as water in foam generation.

### BRIEF SUMMARY OF INVENTION

The exemplary embodiments of the invention involve a nozzle used to project foam. The nozzle comprises a shell to hold the internal components of the nozzle. The nozzle is partitioned by the divider into two primary sections: an input chamber and an output chamber. Attached to the divider are a plurality of tubes that connect to openings in the divider. The base of the plurality of tubes starts at the divider and extends into the output chamber of the nozzle. The plurality of tubes is the only access from the input chamber to the output chamber.

The nozzle in the exemplary embodiment may be connected to a source of foam to be projected. As the foam enters the input chamber, the foam will be forced though the plurality of tubes to enter the output chamber. The plurality of tubes acts as a restriction on the flow of foam into the output chamber, causing the foam to increase speed while the pump pressure remains sat a predetermined level. The plurality of tubes also restricts the perturbations in the direction of the foam. As a result, the foam will be projected farther than otherwise possible with a higher quality of foam.

The methodology of the exemplary embodiment involves discharging water under pump pressure from a pump into an input end of an aeration chamber, where it is combined with foam agent. The combination of the water and foam agent generates foam. The pump pressure forces the water in the aeration chamber at a rate that optimally generates foam. The resulting foam is then discharged under nozzle pressure or under both nozzle pressure combined with pump pressure out the output end of the aeration chamber and through the nozzle, resulting in increased foam velocity and coverage with minimal loss of foam integrity.

### DETAILED DESCRIPTION OF DRAWINGS

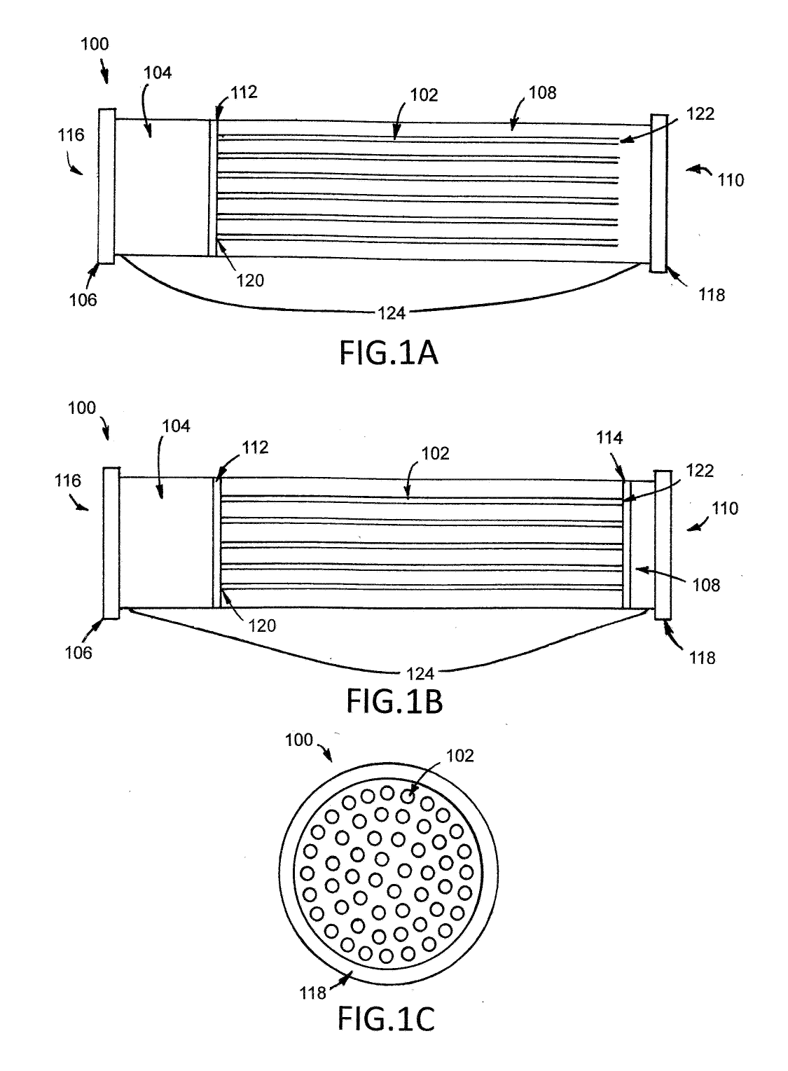

FIG. 1a is an exemplary embodiment of a nozzle using a plurality of tubes in a parallel configuration with a single end of the plurality of tubes coupled to a divider.

FIG. 1b is an alternative exemplary embodiment of a nozzle from FIG. 1a using a plurality of tubes in a parallel configuration with one end of the plurality of tubes coupled to a divider and the other end of the plurality of tubes coupled to a tube support.

FIG. 1c is front view of the exemplary embodiment of a nozzle from FIG. 1a.

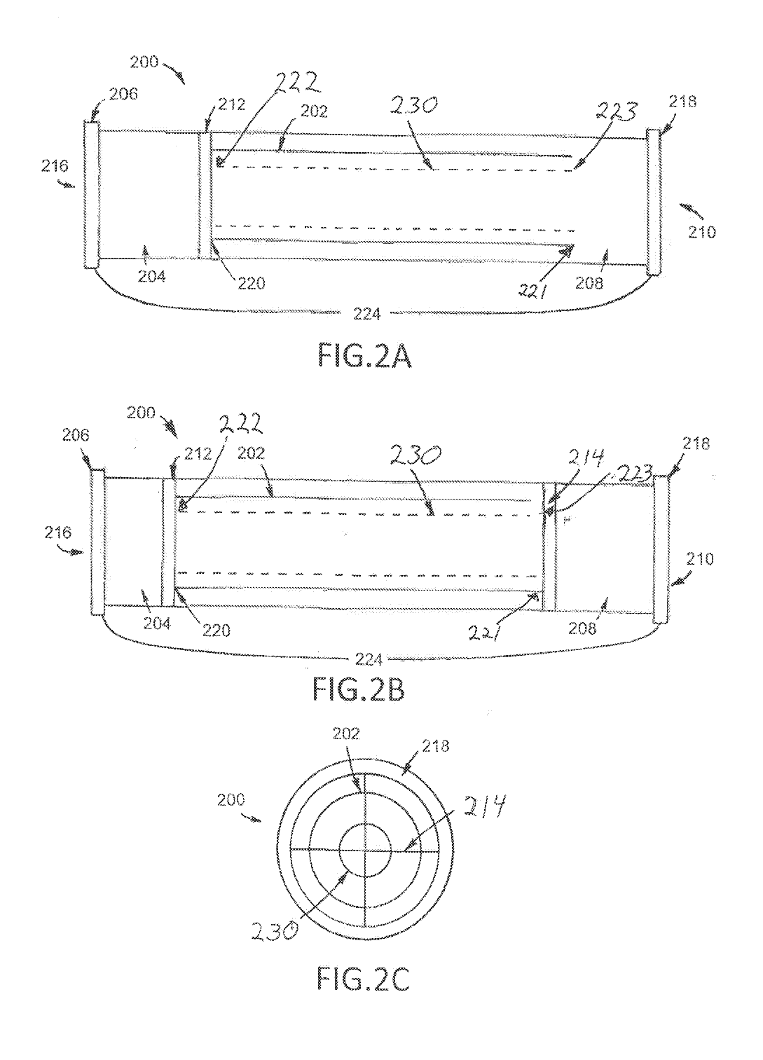

FIG. 2a is an exemplary embodiment of a nozzle using nested tubes with a single end of nested tubes coupled to a divider.

FIG. 2b is an alternative exemplary embodiment of a nozzle from FIG. 2a using nested tubes with one end of a nested tube coupled to a divider and the opposite end of a nested tube coupled to a tube support.

FIG. 2c is front view of the exemplary embodiment of a nozzle from FIG. 2b with a tube support in a cross configuration.

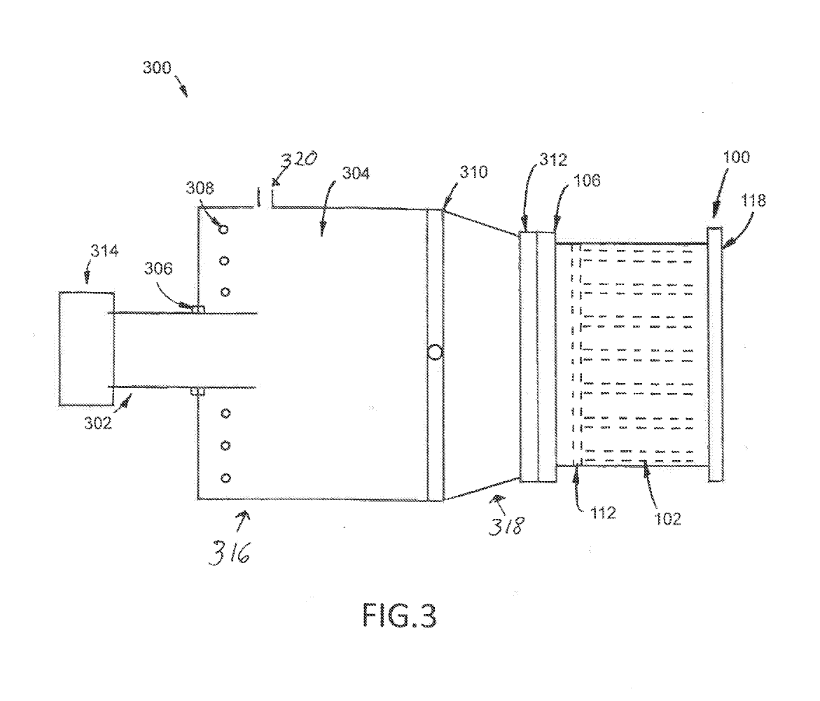

FIG. 3 is a side view of the system using the nozzle of FIG. 1a coupled to an aeration chamber used to generate foam.

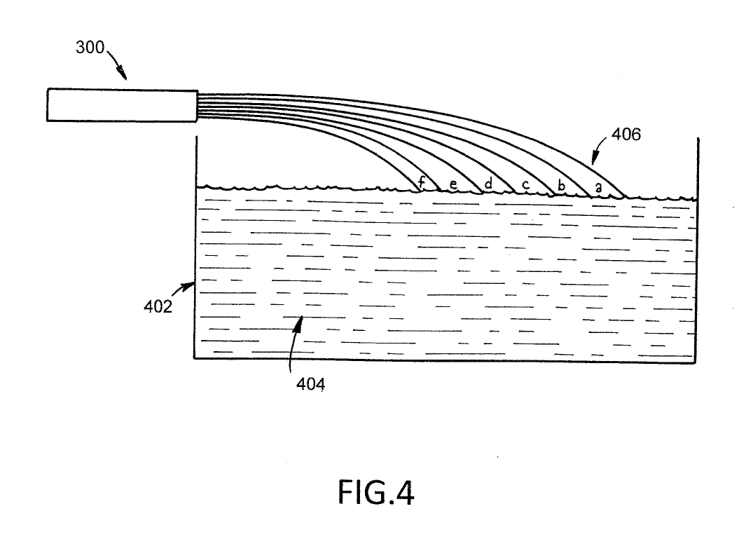

FIG. 4 is a profile view of the nozzle from FIG. 1a where the plurality of tubes of varied sizes cause the foam to discharge over a larger area.

### DETAILED DESCRIPTION OF EXEMPLARY EMBODIMENTS

The disclosed invention utilizes a plurality of tubes in different configurations. The first one is a set of parallel tubes 102 in FIGS. 1a-c, where the parallel tubes 102 may or may not be of uniform diameter. The second is a set of nested tubes with nested outer tube 202 and a nested inner tube 230 in FIGS. 2a-c. While these two are disclosed, it is understood that other configurations with a plurality of tubes are covered by the scope of this disclosure.

The disclosed invention uses nozzle pressure to increase the overall velocity of the foam as it leaves the nozzle 100, thereby increasing the projected area of the foam. The method of applying pressure during foam creation increases the effectiveness of the foam by not damaging the bubbles but still providing sufficient projection. The pump 314 generates pump pressure, which introduces water into the aeration chamber input end 316. Foam agent is introduced in the aeration chamber input end 316 by a foam injector 320, where it mixes with the water to create foam. The pump 314 may generate sufficient pressure to discharge foam at great distance, but if pump pressure is increased beyond the optimal level, then fewer bubbles will form, reducing the effectiveness of the foam. Accordingly, the pump pressure should be at such a level to create maximum bubbles in the foam as opposed to creating the maximum discharge at the expense of foam quality.

Once the foam has formed, the pump pressure continues to force the foam out the aeration chamber output end 318 and into the nozzle 100. The pump pressure may be insufficient of maximum projection of the foam. The restrictions in the nozzle 100 reduce the area the foam may pass through, creating nozzle pressure on the fully formed foam. The fully formed foam now can withstand the increased pressure as it now travels through a more restricted area where there is less opportunity for the foam walls to collide with other surfaces while increasing speed. This increase in velocity allows for greater projection and resulting foam coverage.

An exemplary embodiment of the invention shown in FIG. 1a is a nozzle 100 that projects foam. The outer structure of the nozzle 100 is a shell 124 with a nozzle connector coupler 106 on the nozzle input end 116 and a nozzle discharge guard 118 on the nozzle output end 110. Inside the shell 124, the nozzle 100 has an input chamber 104 and an output chamber 108. Partitioning these two chambers is a divider 112. The only way for the foam to pass from the input chamber 104 into the output chamber 108 past the divider 112 is through the openings in the divider 112 that provide access to the plurality of tubes, which are held in position by the divider 112. The nozzle 100 utilizes a plurality of tubes to control the flow of the foam.

In the first exemplary embodiment, the plurality of tubes is a set of parallel tubes 102. The tube input end 120 of the plurality of tubes are flush with the surface of the divider 112. As the foam reaches the divider 112, the foam passes down the plurality of tubes until it reaches the tube output end 122, where the foam may then be discharged. The plurality of tubes restricts the flow of the foam while minimizing perturbations in the foam and increasing the velocity.

Alternatively, there may be a tube support 114 at the tube output end 122 to provide additional support to the parallel tubes 102 as shown in FIG. 1b. The tube support 114 may further divide the output chamber 108 much like the divider 112, and act in the same manner. FIG. 1c shows a front view of the nozzle 100 where the parallel tubes 102 point out.

In an alternative exemplary embodiment disclosed in FIG. 2a, the plurality of tubes may be nested within each other to form a nested nozzle 200, which has many similarities to the structure of the previously disclosed nozzle 100. The outer structure of the nested nozzle 200 is a shell 224 with a nozzle connector coupler 206 on the nozzle input end 216 and a nozzle discharge guard 218 on the nozzle output end 210. Inside the shell 224, the nested nozzle 200 has an input chamber 204 and an output chamber 208. Partitioning these two chambers is a divider 212. The only way for the foam to pass from the input chamber 204 into the output chamber 208 past the divider 212 is through the openings in the divider 212 that provide access to the plurality of tubes, which are held in position by the divider 212. The nested nozzle 200 utilizes a plurality of tubes to control the flow of the foam.

An inner tube 230 may be nested within an outer tube 202. As with the previous embodiment, the inner tube input end 222 and outer tube input end 220 of the plurality of tubes are flush with the surface of the divider 212. As the foam reaches the divider 212, it passes through opening in the divider 212 in the inner tube 230 and the outer tube 202 until it reaches the inner tube output end 223 and outer tube input end 221, where the foam may then be discharged. By using tubes of different diameters and using the inner tube 230 to obstruct part of the outer tube 202, this changes the impact of the inner tube 230 and the outer tube 202 on the foam, thereby causing different discharge properties based on the differing cross section areas of the plurality of tubes. The nested nozzle 200 may be used in substantially the same manner as the previously disclosed nozzle 100 as they both utilize a plurality of tubes and achieve similar results. All discussions regarding the nozzle 100 also apply to the nested nozzle 200 as well.

In an alternative exemplary embodiment shown in FIGS. 2b-c, the inner tube 230 and outer tube 202 are held in place by an alternative tube support 214 comprising a pair of bars perpendicular to each other that can couple to the inner tube output end 223 and outer tube output end 221 in such a manner that provides support while minimizing obstructions. The alternative tube support 214 is better illustrated in FIG. 2c as a support fused to the inner tube output end 223 and outer tube input end 221. It is understood that this support may be in any configuration.

The above disclosed nozzle 100 may be incorporated into other systems that project foam or other liquids in FIG. 3. The foam forms in an aeration chamber 304 where the water and foam agent mix to create foam. In an exemplary embodiment, the water and foam agent enter the aeration chamber 304 separately with the water entering by the input jet 302 and the foam agent entering from the foam injector 320. In an alternative embodiment, the water and foam agent are mixed together before they enter the aeration chamber 304. The aeration chamber 304 connects to the nozzle 100 by connecting the nozzle connector coupler 106 to the system adaptor 312. The nozzle 100 forces the foam from a system 300 to be discharged in a controlled manner.

When the foam forms in the aeration chamber 304, the velocity of the water aids in foam generation. This input of water also introduces perturbations that may cause the resulting foam to move in directions that are against the flow of the foam. For example, the foam may start to bend in a direction other than the flow of the foam. This tendency of the foam to move in a direction other than with the flow of foam is reduced by the nozzle 100 by restricting the path the foam can travel.

In an exemplary embodiment of the system, an input jet 302 discharges water/foam agent mixture into an aeration chamber 304. The diameter of the input jet 302 is smaller than the diameter of the aeration chamber 304 and extends past the aeration chamber inlet 306. Between the aeration chamber inlet 306 and the end of the input jet 302 are a series of aeration chamber apertures 308 that allow air to enter the aeration chamber 304. The force of the water/foam agent mixture entering the aeration chamber 304 causes the water/foam agent to mix and create foam which expands to a volume that fills the aeration chamber 304. In an exemplary embodiment, an agitation bar 310 may be added to the aeration chamber 304 to partially obstruct the flow of the water/foam agent mixture coming out of the input jet 302. This agitation bar 310 will not appreciable interrupt the flow of the water/foam agent, but will cause sufficient disturbance to generate foam. In an alternate embodiment, the input jet 302 will terminate at the entrance to the aeration chamber 304. The used of the agitation bar 310 is not necessary for all embodiments.

The foam generated in the aeration chamber 304 will then expand. The flow of the water from the input jet 302 will inhibit a majority of the foam from escaping through the aeriation chamber apertures 308. The foam will expand in the nozzle 100, toward the divider 112, and through the parallel tubes 102 as shown in FIG. 1a. The speed of the foam will increase as the foam passes through the parallel tubes 102, even as the pump pressure remains constant. As the foam passes through the parallel tubes 102, nozzle pressure generated by the parallel tubes 102 begins to act on the foam, and any perturbations in the foam will be inhibited by the narrow diameter of the parallel tubes 102 compared with the diameter of the aeration chamber 304. By reducing these perturbations and increasing the velocity of the foam, there is a measurable increase in the distance the foam travels. Further, the increased velocity adds to foam quality and minimizes the damage to the bubbles that occurs when they would otherwise be discharged uncontrollably. By restricting the motion of the foam in the tubes, the bubbles are less likely to impact in inner surface of the nozzle 100, creating less chance for the bubbles to burst. The result is the foam will leave the nozzle 100 with less perturbations in the foam flow, higher velocity of foam discharge, and less damaged bubbles, increasing the foam quality.

Although the exemplary embodiment in FIG. 3 utilized the nozzle 100 with parallel tubes 102 from FIG. 1, it is understood that the system would also work within the scope of the invention using the nested nozzle 200 from FIG. 2 without departing from the scope of the invention.

The embodiment shown in FIGS. 1a-c may have a plurality of tubes that are uniform in diameter. Alternatively, the embodiments in FIGS. 1a-c may have different diameters. The embodiments in FIG. 2a-c also have different diameters. By having different diameters, the foam may be projected different distances simultaneously while under the same pump pressure. This difference in distance travelled may be accounted for by the differing cross-sectional areas available based on the diameter of the plurality of tubes and the mass of the foam leaving the respective tubes. In an alternative embodiment, the flow of foam from the plurality of tubes with different dimensions would interact each other by combining the foam being discharged at different velocities causing the resulting foam streams to spread out and cover a larger foam footprint.

FIG. 4 shows an example of how the invention may generate a larger foam footprint. They system 300 discharges foam to spread on top of a tank 402 containing fuel 404. Instead of the foam being directed to one specific location (example, area 406a in FIG. 4), the differing diameter of the plurality of tubes allows the same nozzle to discharge various streams 406a-f to land in different places under the same pressure.

In an additional exemplary embodiment, the nozzle 100 may be capped with a spindle that may open or close on command. This spindle would receive the foam from the nozzle 100 and open to deploy the foam in a controlled manner.

In an additional exemplary embodiment, the method for discharging foam comprises, supplying water, introducing foam agent into said water, aerating said water to create foam, forcing said foam though a nozzle, and discharging said foam through said nozzle, wherein said nozzle comprises a plurality of tubes. Additionally said water is suppled from an external source. Additionally, said water and said foam agent are combined in an aeration chamber to generate foam. Additionally, said foam is generated in a manner that directs said foam through said nozzle.

In an additional exemplary embodiment, the method for discharging foam comprises filling an input chamber with foam, forcing said foam through a plurality of tubes, and discharging said foam through said plurality of tubes. Additionally, filling said input chamber with foam utilizes at least one of positive flow and/or positive pressure.

One of skill in the art will appreciate that embodiments provide improved nozzles for the projection of foam and other fluids. Although specific embodiments are illustrated and described herein, it will be appreciated by those of ordinary skill in the art that any arrangement which is calculated to achieve the same purpose can be substituted for the specific embodiments shown. This specification is intended to cover any adaptations or variations of embodiments. In particular, one of skill in the art will appreciate that the names and terminology are not intended to limit embodiments. Furthermore, additional apparatus can be added to the components, functions can be rearranged among components, and new components corresponding to future enhancements and future physical devices used in embodiments can be introduced without departing from the scope of the invention. The terminology used in this application is intended to include all embodiments and alternatives which provide the same functionality as described herein.

1. A nozzle for discharging fluid, comprising:
a. A shell;
b. A divider coupled to the interior surface of said shell; and
c. A plurality of tubes within said shell coupled to said divider;
d. Wherein said divider partitions said shell into an input chamber and an output chamber;
e. Wherein said plurality of tubes allow access between said input chamber and said output chamber;
f. Wherein said input chamber comprises an input aperture; and
g. Wherein said output chamber comprises an output aperture.

2. The nozzle of claim 1, wherein said plurality of tubes couples to said divider in a manner such that fluid may enter said input chamber, pass the divider through said plurality of tubes, and exit said output chamber.

3. The nozzle of claim 2, wherein the passage of fluid through said plurality of tubes reduces any forces that conflict with the flow of said fluid going parallel to the path of said plurality of tubes.

4. The nozzle of claim 2, wherein the passage of fluid through said plurality of tubes increases the fluid velocity.

5. The nozzle of claim 1, wherein said nozzle can connect to a fluid source.

6. The nozzle of claim 1, further comprising a coupling mechanism to connect said shell with a fluid source.

7. The nozzle of claim 6, wherein fluid from said fluid source enters said input chamber.

8. The nozzle of claim 1, wherein said input chamber further comprises a nozzle connector coupling that encircles said input aperture.

9. The nozzle of claim 1, wherein said output chamber further comprises a nozzle discharge guard that encircles said output aperture.

10. The nozzle of claim 1, wherein said plurality of tubes compromise a series of tubes in parallel.

11. The nozzle of claim 1, wherein said plurality of tubes comprises an inner nested tube surrounded by an outer nested tube.

12. A system for discharging foam, comprising:
a. A fluid supply containing fluid;
b. A foam agent supply containing foam agent;
c. An aeriation chamber capable of receiving said fluid from said fluid supply and said foam agent from said foam agent supply to create foam; and
d. A nozzle capable of projecting said foam;
e. Wherein said nozzle comprises a plurality of tubes connecting an inner chamber of said nozzle to an outer chamber of said nozzle.

13. The system of claim 12, wherein said plurality of tubes comprises a series of tubes in parallel.

14. The system of claim 12, wherein said plurality of tubes comprises:
a. An outer tube; and
b. An inner tube nested within said outer tube.

15. The system of claim 12,
a. Wherein said aeration chamber has at least one aerating opening to allow access to air; and
b. Wherein said fluid and said foam agent enter said aeration chamber with enough force that a majority of said foam generated discharges out said plurality of tubes.

16. The system of claim 12,
a. Wherein said fluid enters said aeration chamber based in part on pump pressure; and
b. Wherein said foam discharges out of said nozzle based in part on nozzle pressure.

17. The method for discharging foam, comprising:
a. Discharging fluid under pump pressure from a pump into an input end of an aeration chamber;
b. Introducing a foam agent in said aeration chamber;
c. Generating foam in said aeration chamber by combining said fluid and said foam agent; and
d. Discharging said foam under nozzle pressure through a nozzle at the output end of said aeriation chamber;
e. Wherein said pump pressure forces said fluid into said aeration chamber in such a manner that the foam generated in said aeration chamber is at an optimum level for foam formation; and
f. Wherein said nozzle restricts the output of said foam resulting in said foam being discharged under the combined pressure of said pump pressure and said nozzle pressure.

18. The method of claim 17, wherein said nozzle comprises a plurality of tubes.

19. The method of claim 18, wherein said nozzle further comprises:
a. A shell;
b. A divider coupled to the interior surface of said shell; and
c. Wherein said plurality of tubes within said shell coupled to said divider;
d. Wherein said divider partitions said shell into an input chamber and an output chamber;
e. Wherein said plurality of tubes allow access between said input chamber and said output chamber;
f. Wherein said input chamber comprises an input aperture; and
g. Wherein said output chamber comprises an output aperture.

20. The method of claim 17, wherein said nozzle and said aeration chamber may be a single unit.
